(19) United States
(12) Patent Application Publication
(10) Pub. No.: US 2009/0112751 A1
(43) Pub. Date: Apr. 30, 2009

(54) 2-Phase auction design and implementation

(76) Inventors: Brad Miller, Medfield, MA (US); Benny Moldovanu, Bonn (DE)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/288,029

(22) Filed: Oct. 16, 2008

Related U.S. Application Data
(60) Provisional application No. 60/980,416, filed on Oct. 16, 2007.

(51) Int. Cl. G06Q 40/00; G06F 17/30

(52) U.S. Cl. 705/37

(57) ABSTRACT

A system and method for implementing and conducting a 2-phase clock and sealed-bid auction for a multi-part product includes more than one remote computer stations connected to a network, a web server to receive and store bid information and auction parameters. The web server can include application software configured to initiate a clock phase and a sealed-bid phase. The clock phase generally includes presenting bidders with an initial price structure for the multi-part product, receiving bids from each of the bidders, storing the bids, and comparing the bids to a transition rule. The software can initiate the sealed-bid phase based on the comparison between the bids and the transition rule. The seal-bid phase generally includes providing sealed-bid parameters to the bidders, receiving a sealed-bid from the bidders, and determining an auction winner based on a selection rule.

### CROSS-REFERENCE TO RELATED ACTIONS

This application is related to and claims the priority of U.S. Provisional Application Ser. No. 60/980,416 filed Oct. 16, 2007 and incorporated herein by reference.

### BACKGROUND

This invention generally relates to auction systems. More particularly, this invention relates to 2-phase format auctions including, for example, an ascending clock phase and a sealed-bid phase. In that historical example, the combination of an ascending auction (e.g., “English” auction), and a sealed-bid auction (e.g., “Dutch” auction), is called an “Anglo-Dutch” auction and generally captures the benefits of both auction format approaches. For example, the 2-phase auction can help reduce predatory and collusive behavior that can be associated with a standard ascending auction. While the general format of the 2-phase auction can improve the behavior of the participants, the actual process flow, rules and parameters of the implementation can further help to provide satisfactory results. In some cases, the design of an auction follows an ad hoc processes which is heavily customized for the particular products which are being sold or purchased. This customization can lead to difficulties and inefficiencies when different products become the subject of the auction. Accordingly, there is a need for a more systematic approach to the design, processing algorithms, and implementation of 2-phase auctions.

### SUMMARY OF THE INVENTION

In general, in an aspect, the invention provides a system for implementing and conducting a 2-phase clock and sealed-bid auction for a multi-part product including one or more remote computer stations connected to a network and configured to receive bids from bidders, a web server operative to receive and store the bid information from the remote computer stations, receive and store auction parameters from an auction manager, and including application software configured to initiate a clock phase and a sealed-bid phase, such that the clock phase includes presenting the bidders with an initial price structure for the multi-part product, receiving at least one bid for the multi-part product from each of the bidders within a defined time window, storing the at least one bid for each of the bidders, comparing the auction parameters and bids to a transition rule, performing an end-of-round calculation, presenting the results of the end-of-round calculation to each of the bidders, the software can also initiate the sealed-bid phase based on the comparison between auction parameters and bids to the transition rule, such that the seal-bid phase includes providing sealed-bid parameters to at least a subset of the bidders, receiving a sealed-bid from at least a subset of the bidders, and determining auction results based on a selection rule, such that the stored auction parameters includes at least the initial price structure, the defined time window, the transition rule, and the selection rule.

Implementations of the invention may include one or more of the following features. The price structure of the multi-part component and the bids can include a price component and a quantity component. The transition rule can be calculated by comparing the quantity of each product being auctioned to the quantity of bids for each product. The end-of-round calculation can include incorporating a price adjustment for at least one of the parts in the multi-part product. The defined time window in the clock phase can be approximately between 1 and 60 minutes. The selection rule can include at least one rule for each part in the multi-part product. The clock phase can be an ascending-price clock phase or a descending-price clock phase.

In general, in another aspect, the invention provides a computer-readable medium having computer-executable instructions for performing a 2-phase clock and sealed-bid auction for a multi-part product, including maintaining an auction bidding web site, storing a more than one auction parameters from an auction manager including at least an initial price structure, a first and a second defined time windows, a transition rule, and a selection rule, providing a more than one bidders with access to the web site, presenting the bidders with auction rules and the initial price structure, initiating a clock-phase including receiving through the web site a first bid for the multi-part product from each of the bidders within the first defined time window, storing the at least one bid for each of the bidders, comparing auction parameters and bids to the transition rule to determine if the clock-phase should continue, performing an end-of-round calculation, presenting the results of the end-of-round calculation to each of the bidders via the web site, if the clock-phase continues, then receiving through the web site a second bid for the multi-part product from each of the bidders within the second defined time window, if the clock-phase will not continue, then initiating a sealed-bid phase such that the seal-bid phase includes, providing sealed-bid parameters to at least a subset of the bidders, receiving a sealed-bid from at least a subset of the bidders, and determining the auction results based on the selection rule.

Implementations of the invention may include one or more of the following features. The clock phase is can be an ascending-price clock phase or a descending-price clock phase. The first defined time window can be longer in duration than the second defined time window.

In general, in another aspect, the invention provides a method for implementing a 2-phase clock and sealed-bid auction for a multi-part product, including maintaining a database of auction parameters including at least an initial price structure and a transition rule, providing a plurality of bidders with access to the a web site, such that the web site is connected to the database, presenting the bidders with the initial price structure via the web site, initiating a clock-phase including receiving through the web site a bid for associated with the multi-part product from each of the bidders, storing the at least one bid for each of the bidders in the database, performing an end-of-round calculation, presenting the results of the end-of-round calculation to each of the bidders via the web site, initiating a sealed-bid phase based on the auction parameters, the bids received in the clock phase, and the transition rule, such that the seal-bid phase includes, providing sealed-bid parameters to at least a subset of the bidders, receiving a sealed-bid from at least a subset of the bidders, and determining the auction results.

Implementations of the invention may include one or more of the following features. The clock phase can be an ascending-price clock phase or a descending-price clock phase. The sealed-bid round may not occur and the auction results are determined based on the auction parameters and the bids received in the clock phase. The clock-phase may not occur based on the auction parameters, and the auction results are determined based on the auction parameters and the bids received in the sealed-bid round. The price structure of the multi-part component and the bids can include a price component and a quantity component, and the transition rule is calculated by comparing the quantity of each product being auctioned to the quantity of bids for each product. The bid information in the clock phase and the sealed-bid phase can be received via email. The bid information in the clock phase and the sealed-bid phase can be received via a facsimile system.

These and other capabilities of the invention, along with the invention itself, will be more fully understood after a review of the following figures, detailed description, and claims.

### BRIEF DESCRIPTION OF THE FIGURES

FIG. 1 is a flow chart of an exemplary 2-phase auction process.

FIG. 2 is an exemplary auction design and implementation plan.

FIG. 3 is an exemplary auction network.

### DETAILED DESCRIPTION OF PREFERRED EMBODIMENTS

Embodiments of the invention provide a process for designing and implementing auction methods. This process is exemplary, however, and not limiting of the invention as other implementations in accordance with the disclosure are possible.

In general, auction design and implementation is aimed at assisting an auctioneer conduct an auction successfully. The auctioneer can be the selling party in a forward auction or the buying party in a reverse auction. An auction manager can be a computerized system, or a person, or a combination of both that assist in managing the implementation of the auction. The items that can be auctioned can be physical goods, commodities, assets, liabilities, contracts, services, or other rights and obligations which can be bought or sold. There can be one item in an auction, or multiple items (i.e., multi-part). Multiple items can be grouped, and can have pricing relationships among them. In an embodiment, the items/products to be auctioned include more that one unit (e.g., 100 blocks of a 3-year contract, 200 blocks of a 5-year contract, and 250 blocks of a 7-year contract, where each block equals 1 MW of electrical power). For example, there can be 3 products (e.g., 3 different contracts), each with a different number of units or blocks. The number of units for each product do not have to differ. The rules, guidelines, and auction manager discretion can be stored and executable via programmable computers, or via human intervention. In an embodiment, the auction can be executed automatically over a wide area through the use of computers and associated networking structures. For example, the auctioneer, bidders, and auction manager can be located in different locations and information can flow over the computer network.

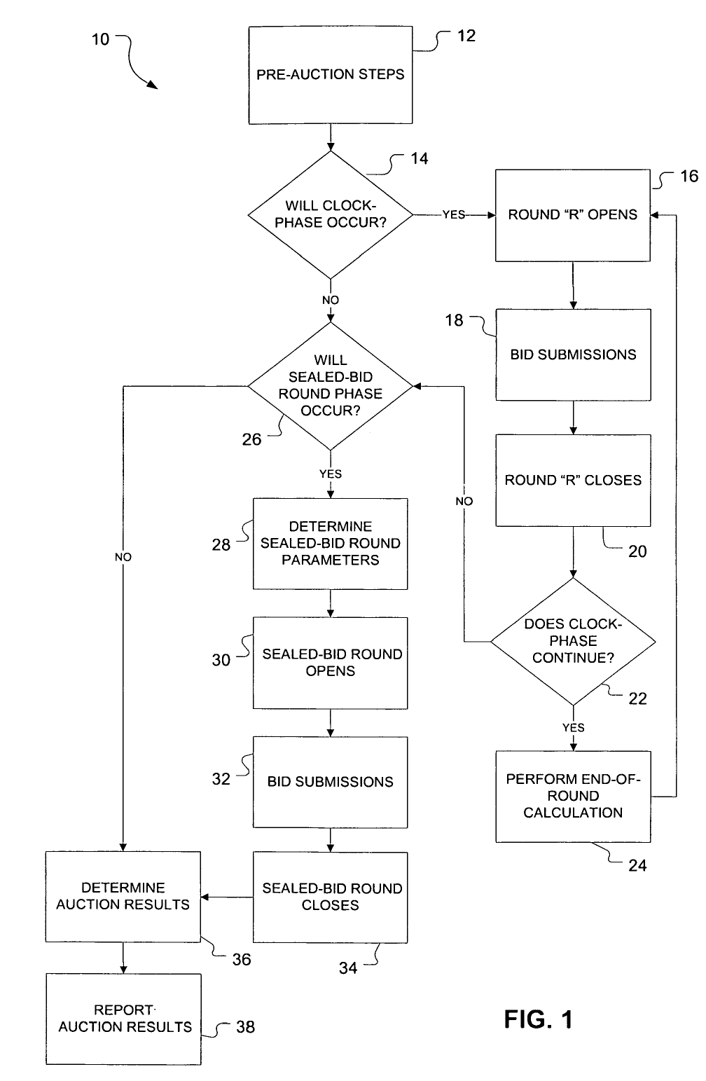

Referring to FIG. 1, an exemplary 2-phase auction process 10 is shown. The process 10, however, is exemplary only and not limiting. The process 10 may be altered, e.g., by having stages added, removed, or rearranged.

At stage 12 the pre-auction steps are completed. Generally, an auction manager will manage the pre-auction steps. These steps can include, for example, preparing auction related documents such as information memoranda, auction participation agreements, confidentiality agreements, and term sheets. Bidder qualification can also be an important part of the pre-auction step. For example, bidders may be required to submit a pre-auction bid bond, sign a non-collusive agreement, or other steps required by the auction manager. The initial parameters for the auction can be established. For example, the auction quantities, starting prices, and schedule of rounds are determined. The auction manager can also establish the rules and guidelines to determine quantity adjustment rules, bid quantity constraints, price adjustment rules, and transition rules. The rules can be used by the auction manager to determine if a clock phase will take place, and if so, when the clock phase will end and when the sealed-bid phase will take place. The rules for establishing the bid selection criteria to determine winning bids and closing prices are also completed in the pre-auction step.

When the auction includes multiple products, the auction design and implementation should accommodate the special relationships that may be associated with the products. For example, bidders should have a way to express their preferences among the products. That is, for substitutable products, bidders should be allowed to pursue price arbitrage opportunities. For complementary products, bidders should be allowed to pursue preferred packages of products. The bidding eligibility rules should take into account all products and/or sub-groups of products. Further, price adjustments during the auction, if any, should consider the relationship among the products. For example, prices for the products may change absolutely and/or relatively to reflect price relationships among the products.

At stage 14 a determination is made on whether a clock phase (CP) will occur. Based in the pre-auction step 12, the auction manager determines whether the clock phase will occur. If the clock phase will be run, then round one (i.e., R=1, of stage 16) of the auction will be the first round of the clock phase. If the clock phase will not occur, then the sealed-bid round (SBR) 26 will be conducted. In this case, the sealed-bid round is the only round of the auction. For example, if indications prior to the start of the auction are that the quantity to be bid in the first round is close to the quantity being auctioned, or if there is an insufficient number of bidders, then the auction rules may call for skipping the clock phase, or the auction rules may allow the auctioneer or auction manager discretion to skip the clock phase.

At stage 16, the round of bidding “R” opens. In general, rounds of bidding are scheduled for a time specified in the pre-auction steps 12. The auction manager can also delay the start of the round based on technical difficulties experienced by bidders, or other criteria established in stage 12.

At stage 18, bids can be submitted. In an embodiment, a bidder can submit multiple bids within a round as long as the round remains open for bidding. In general, and as would be described in the auction documents, the last bid submitted by a bidder in the round replaces any bid previously entered by the bidder in the round. If a bidder who is eligible to bid in the round does not bid in the round, a default bid can be submitted on its behalf.

At stage 20, the round of bidding “R” closes. In general, rounds of bidding are scheduled for a time specified in the pre-auction steps 12. The auction manager can also extend the closing time of a round. For example, the round can be extended based on criteria established in stage 12.

At stage 22, a determination is made on whether the clock phase will continue. In an embodiment, a transition rule can be established in the pre-auction steps 12 to direct the auction manager to whether to continue with next round of the clock phase (i.e., R=R+1 at stage 16), or whether the round just ended is the last round. The transition rule is an important element in that is intended to capture the benefits of both clock processes and sealed-bid formats. The benefits of the clock phase include providing for an effective price discovery process through mitigating winner's curse effects of common values and through allowing bidders to arbitrage among products that are substitutes and to pursue packages of products that are complements. The benefits of the sealed-bid phase include encouraging as many bidders as possible to participate in the auction, mitigating collusive behavior among bidders, determining winning quantities when otherwise there would be excess demand or excess supply, determining more precise clearing prices, and allowing the auction manager to control the timing of the close of the auction. For single-product 2-phase auctions, the transition rule can be straightforward. For example, a transition rule can be a parameter based on demand when bidders are competing to purchase blocks of the product. Parameters such as price and quantity of the product, and number of bidders remaining in the auction can be used in the transition rules. One transition rule could be that the clock phase ends when the total quantity bid falls below 105 percent of the quantity being auctioned. For auctions with multiple products, the transition rule needs to be more complex. For example, the transition rule needs to account for the scenario in which the quantity bid for one product in the clock phase falls below the quantity auctioned for the product, but the quantity bid for another product is above the quantity auctioned for that product. For example, the transition rule could be that the clock phase ends when for each product the quantity bid falls below a maximum quantity being auctioned for the product. In general, the transition rule is established during the pre-auction steps, and is not disclosed to the bidders.

At stage 25, end-of-round calculations are performed. In general, the calculations can include measuring the quantity bid (i.e., demand in a forward auction, supply in a reverse auction), subscription levels (i.e., the quantity of the bids submitted by bidders relative to the quantities being offered by the auctioneer), adjustments to the auction quantities, adjustments to bidding constraints on bidders (e.g., bidder's eligibilities), adjustments to prices to determine the announced prices for the next round. Other calculations can be performed based on the nature of the products in the auction. The results of the calculations are generally reported to the bidders in a condensed format. The exact format and timing will be established and published in the pre-auction steps 12.

At stage 26, a determination is made on whether a sealed-bid round will take place. The requirements for the decision are included in the pre-auction steps 12. An example of when the sealed-bid round would not take place is if there is a round in which for each product the quantity bid equals the quantity auctioned, or the quantity bid falls within a range of the quantity auctioned. If a sealed-bid round is required, the auction manager determines sealed-bid round parameters at stage 28. The parameters can include, for example, which bidders must or can submit bids, the quantity each bidder must bid, and any restrictions on the prices which bidders can submit. The parameters and restrictions can be relatively straightforward in a single-product 2-phase auction. For example, each bidder must bid a price in the sealed-bid round for each block the bidder bid in the penultimate round of the clock phase. One challenge for a multi-product 2-phase auction is to determine the parameters and restrictions so that each product can be brought into demand-supply balance because each product may have had excess demand and/or excess supply in different rounds in the clock phase. One example is to determine the last round in the clock phase in which each product had more quantity bid than the quantity being auctioned. This round determines the quantities (e.g., blocks) each bidder must bid in the sealed-bid round. For each block the bidder bids in the sealed-bid round, the bidder must bid a price in the sealed-bid round that is no less favorable to the auctioneer than the most favorable price the bidder bid the block at in the clock phase.

At stage 30, the sealed-bid round opens as proscribed by the auction manager. The scheduled starting time is generally described in the pre-auction steps 12, but can be delayed by the auction manager. At stage 32, the bids are submitted. In an embodiment, a bidder can submit multiple bids within the sealed-bid round as long as the sealed-bid round remains open for bidding. Typically, the last bid submitted by a bidder is the sealed-bid round replaces any previously entered bid. If a bidders who is eligible to submit a bid at stage 32, but does not submit a bid, a default bid can be submitted on its behalf. The sealed-bid round closes at stage 34 according to a scheduled ending time. The auction manager can extend the time of the sealed-bid round

At stage 36, the auction results can be determined. Using the rules and guidelines established in the pre-auction steps 12, the auction manager determines the winning bids, the winning bidders, and the closing prices. In some auctions, tie-breaker rules may be needed to select among two or more bids. Alternative tie-breaker rules are also within the scope of the process. In an embodiment, different pricing rules can be used to determine the closing prices (e.g., uniform pricing or pay-your-bid (forward auction), or paid-your-bid (reverse auction)) can be used.

At stage 38, the auction manager can report the auction results to the auctioneer, to bidders, and possibly other parties.

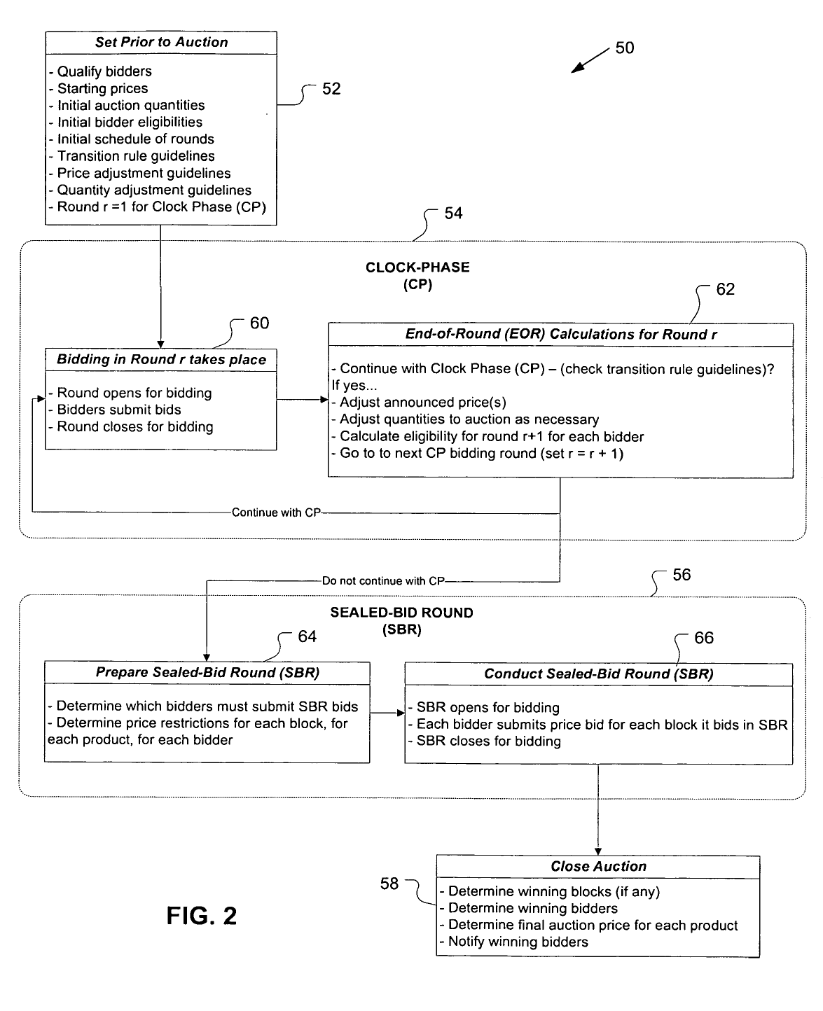

Referring to FIG. 2, an exemplary auction design and implementation plan 50 includes the stages shown. The design 50, however, is exemplary only and not limiting. The process 10 may be altered, e.g., by having stages added, removed, or rearranged.

The example auction design and implementation plan 50 can include a design stage 52, a Clock Phase (CP) 54, a Sealed-Bid Round (SBR) 56, and a close auction stage 58. In an embodiment, the clock phase 54 can include a series (i.e., “r” number) of bidding rounds 60, and an End-of-Round (EOR) calculation stage 62. The SBR 56 can include a prepare stage 64, and a conducting stage 66.

At stage 52 an auction designer collects and assesses the variables associated with the auction. The process 50 can be modified based on the nature of the sellers, the bidders, and the items to be auctioned, for example. Other criteria include objectives of the auctions (e.g., is it in response to regulatory or institutional requirements), whether the values of the items are common across bidders, or whether they have private value specific to each bidder. Based on these, and other market criteria, an auction manager can establish the auction rules. As an example only, and not a limitation, the following variables can be set prior to the auction:
Qualify Bidders: a bidder can be qualified based on a credit rating or other type of bond or security.
Starting Prices: initial prices can be set based on requirements of the auctioneer in combination with other market factors.
Initial Auction Quantities: the quantities can include physical measurements of goods, as well as time-based contracts. For example, an auction product can include blocks of power (e.g., electricity) to be consumed over a time period.
Initial Bidder Eligibilities: in general, a maximum number of units or blocks that a bidder can bid on will be assigned. Each bidder will be aware of this maximum prior to the start of the auction. The maximums could be product-specific and/or in effect for the bidder's total quantity it can bid across all products.
Initial Schedule of rounds: prior to the start of the auction, the auction designer, or auction manager, will announce the scheduled start and end times of the first rounds of the CP 54. As the CP 54 progresses, the auction manager will keep the bidders informed of the scheduled start and end times of future rounds.
Transition Rule Guidelines: as described above, the rule that determines the last round of bidding in the CP 54—and therefore the rule that determines that the next round is the SBR 56—is referred to as the transition rule. For example, the transition rule can be that the last round of bidding in the CP 54 is the first round of bidding in the CP 54 in which excess demand falls below a threshold number of blocks of excess demand. This threshold number of blocks of excess demand either will be zero or will have a positive value and will be determined prior to the start of the auction. Typically, the threshold parameter value is not disclosed to bidders.
Price and Quantity Adjustment Guidelines: an auction plan can include special rules to modify the prices, quantities, or the transition rule, once the auction is underway.

The CP 54 can be a simultaneous, multiple-round, ascending-price clock bidding process (e.g., an Ascending Clock Phase). The CP can also be a descending-price clock bidding process. The CP 54 can be a simultaneous bidding process because, for example, two products can be offered for sale simultaneously. For example, in accordance with established auction rules, a bidder can bid on one or both products in a round. The CP 54 can be a multiple-round, ascending-price clock bidding process because bidding can occur in discrete rounds of bidding. Before each round, the auction manager can announce the price for each product. The announced price for each product can stay the same or increase from round to round. The announced prices continue to “tick up” round by round similar to the hands of a clock.

In general, at stage 56, the sealed-bid round 56 can be the next round of bidding after the final round of bidding in the CP 54. In an embodiment, there can be one sealed-bid round, and it can be the final round in the auction. For ease of description, the last round of the CP 54 can be referred to as “round N” and the next to last round of the ascending clock phase 54 can be referred to as “round N 1.” N, however, need not be pre-determined.

At stage 58, an established auction closing rule 58 can determine when the auction is completed; how many items, if any, are sold; how many items, if any, each bidder has won for each product; and the price—i.e., the auction premium—that will be paid by winning bidders for each item won. After the end of the SBR 56, the auction can close. At the close of the auction, the winning bidders can be determined and the product-specific auction premiums can be determined.

In general, auction systems can be installed on computer systems via a computer-readable medium containing computer-executable code. Computer-readable medium can be broadly defined as any kind of computer memory such as floppy disks, conventional hard disks, CD-ROMS, Flash ROMS, nonvolatile ROM, and RAM. Further, these computer systems are typically connected to a network (e.g., LAN, WAN, the Internet) and can be configured to receive computer-executable code through the network. An auction manager and auction participants can exchange bid information over the network via computers and servers.

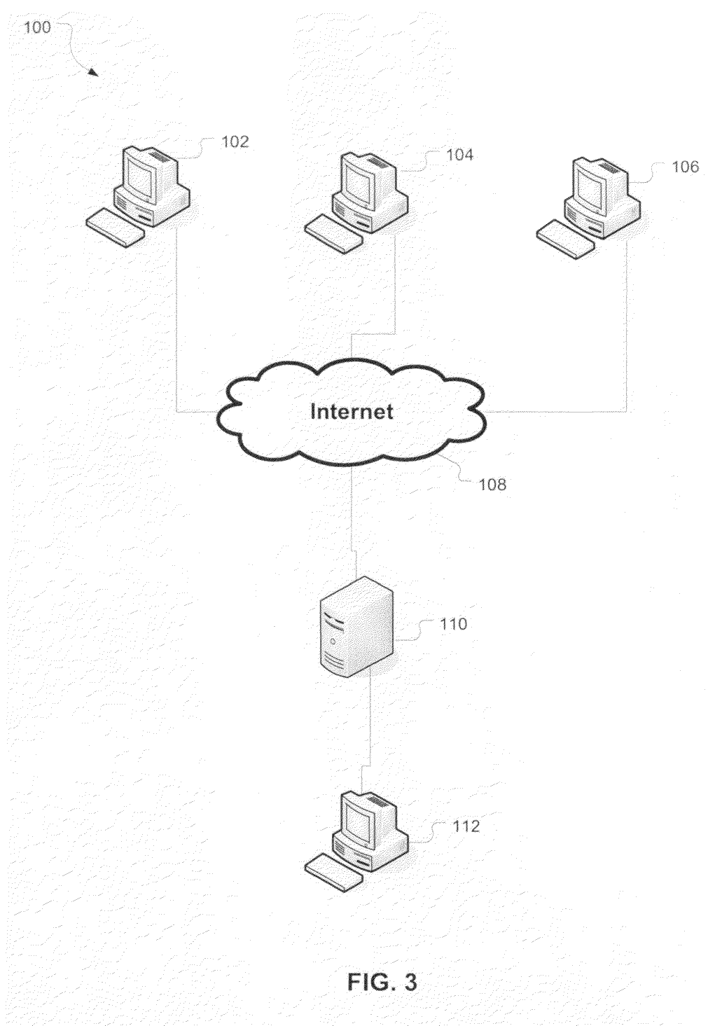

Referring to FIG. 3, an exemplary auction network 100 is shown. The network includes remote computer stations 102, 104, 106, which are configured on networks such as the Internet 108, an application server 110, and an administrator computer workstation 112. In general, the computer stations 102, 104, 106, 112 can include a processor, memory, display device, and operating software such as Microsoft Windows® or Linux. Other networked equipment such as fax machines, scanners and printers may be used. The computers 102, 104, 106, 112 are configured to display and receive information as known in the art. The network 100 can be configured to perform cohesively such that the individual components (i.e., processors, memory, software) on each of computer stations and servers can coordinate processing, storage and display tasks as known in the art.

In general, the auctions are conducted to a global market and the computer network 100 is configured to utilize the Internet. The server 110 can be based on Microsoft applications (e.g., Windows Server), or other programs such an Unix. In general, the auction system resides on the server 110, however, in an embodiment, elements of the auction system can also reside on the computer stations 102, 104, 106, 112. As described above, the computer network 100 is configured to receive, store and disseminate auction information from the auctioneer, bidders and auction manager. For example, timing elements such as the schedule of rounds, opening and closing of the clock and sealed-bid phases can be stored in the network 100. Bid information and transition rules can be stored and used as input by auction managers or auction manager software to trigger auction events. For example, at stage 22 the network 100 can be configured to determine whether to stop the clock phase based on a transition rule stored in memory. In an embodiment, other stages of the process 10 can be automated. The network 100 can be configured to interact with existing business application such as email and print servers for data collection and dissemination. For example, clock round and sealed-bid information can be received and transmitted via email. Auction reports can be emailed, posted to a Web site and/or sent to print servers to produce hard copies. An auction manager can communicate to bidders via instant messaging application, voice over IP, or the Web browser.

An exemplary set of auction rules based on the auction design and implementation process 10 are included below:

### Example Auction Rules

At stage 12, the auction manager determines the products to be auctioned. In this example, and electrical power company called MegaVoltCorp is trying to sell Transmission Scheduling Rights (TSRs). There are three products offered for sale in the MegaVoltCorp Auction: a 3-year contract, a 5-year contract, and a 7-year contract. Across these contracts, Seller would like to sell up to a total of 300 MW of TSRs by auctioning up to 12 Auction Blocks of 25 MW each. All 12 Auction Blocks will be offered for sale at the start of the auction, but the number of Auction Blocks offered for sale may be reduced during the auction if it appears the auction otherwise will not be successful.

The auction manager determines that the MegaVoltCorp Auction should be a 2-phase format with an ascending clock phase and a sealed-bid phase. The auction format begins with an ascending clock phase 14. In each round of this phase, a Qualified Bidder bids the total number of Auction Blocks it would purchase given the three product-specific prices announced for the round by the Auction Manager. The Qualified Bidder does not specify the product(s) it is bidding on, only the total number of Auction Blocks across the products.

After each round, in stage 24, Qualified Bidders are provided with results for the round that give an indication of the aggregate demand (the total number of Auction Blocks bid by all Qualified Bidders) at the round's announced prices. Qualified Bidders also are informed of the next round's prices, which are increased by some increment over the announced prices in the round that just closed.

This feedback after each round provides Qualified Bidders with information on how their competitors in aggregate view the value of the Auction Blocks being offered in the auction. Such information assists Qualified Bidders in fine-tuning their own value estimates, mitigates the “winner's curse” effect, and promotes effective price discovery.

At stage 22, if the aggregate demand falls below some pre-determined threshold number of Auction Blocks (that is greater than or equal to the number of Auction Blocks that are offered for sale), the ascending clock phase ends and the auction moves to the sealed-bid round (i.e., stage 26), in which a Qualified Bidder bids a price for each Auction Block on which it is bidding. The sealed-bid round allows Qualified Bidders to submit precise best-and-last-offers.

In this example, there is no selection of Winning Bidders by the Auction Manager. It is only at the end of the MegaVoltCorp Auction that Winning Bidders are determined as those Qualified Bidders who have submitted the best bids. Winning Bidders are obligated to satisfy the remaining requirements in the Auction Participation Agreement and the TSR Purchase Agreement, including providing the Required Collateral Amount (if any), at the close of the auction.

The detailed rules and procedures of the auction format that will be used for the MegaVoltCorp Auction are described below.

The auction format for the exemplary MegaVoltCorp Auction is an ascending clock auction for “N” rounds (N is not pre-determined, as discussed below) followed by a final round, “N+1”, in which sealed bids are submitted. The ascending clock rounds are referred to collectively as the “ascending clock phase.” The single sealed-bid round, which also is the final round of the MegaVoltCorp Auction, is referred to as the “sealed-bid round.”

The pricing rule for the MegaVoltCorp Auction is uniform pricing. This means all Winning Bidders pay the same price for a particular product, referred to as the Auction Closing Price for the product.

The number of rounds for the ascending clock phase is not pre-determined. Instead, it is determined by a transition rule.

The ascending clock phase (i.e., stages 16 through 24) can be conducted with rounds of bidding. Each round has a specified start time and a specified end time, as proscribed in the pre-auction steps 12.

In this example, a Qualified Bidder's “Eligibility” to bid in a round is the maximum number of Auction Blocks the Qualified Bidder can bid in the round. A Qualified Bidder's Eligibility at the start of the auction—that is, the maximum number of Auction Blocks that a Qualified Bidder is allowed to bid in round 1 of the auction—will be communicated by SELLER in the Qualified Bidder Notice sent to the Qualified Bidder prior to the auction in the pre-auction steps 12. A Qualified Bidder's Eligibility in a particular round starting with round 2 is simply the number of Auction Blocks that it bid in the preceding round. Thus, note that a Qualified Bidder's Eligibility cannot increase during the ascending clock phase, it can only remain the same or decrease from round to round.

In this example, an “Active Bidder” is a Qualified Bidder who has positive Eligibility to bid in a round—that is, it can bid at least one Auction Block in the round. If and when an Active Bidder's Eligibility falls to zero in the ascending clock phase, it no longer is an Active Bidder in the ascending clock phase and it no longer can submit bids in the ascending clock phase.

Active Bidders submit bids only during a round. When a round ends, at stage 24 the bids submitted during that round are processed and results of that round are reported to all Qualified Bidders who were Active Bidders as of the beginning of that round. Each Active Bidder then prepares to submit a bid for the next round.

Prior to the start of each round in the clock phase, the Auction Manager announces the price (“Announced Price”) for each product that will be in effect for the round. The product-specific Announced Prices are specified in dollars per kW-month, or $/kW-month. The Announced Prices apply to all the Auction Blocks—different Auction Blocks are not assigned different products or different Announced Prices.

Each Active Bidder decides how many Auction Blocks it is willing and able to commit to purchasing at the Announced Prices. An Active Bidder does not specify which product it is willing and able to commit to purchasing for each Auction Block. A bid is simply a number of Auction Blocks specified by the Active Bidder. As discussed later in these Bidding Rules, after the auction closes and is determined to be successful, each Winning Bidder will select which product it is buying for each of the Auction Blocks won by the Winning Bidder.

It is intended that the product-specific Announced Prices will be related to each other by a formula (“Price Indifference Formula”) that leaves SELLER indifferent among the products. This formula will be provided to Qualified Bidders prior to the start of the auction. In consultation with the Auction Manager, SELLER has discretion to direct the Auction Manager to set Announced Prices that deviate from this formula but it does not expect to exercise that discretion unless it appears the auction otherwise will not be successful.

The Announced Prices will increase round by round by price increments. The price increments generally will follow guidelines that relate the price increments to the level of Excess Demand from the round just ended: the greater is Excess Demand, the larger are the price increments. “Excess Demand” in a round is the total number of Auction Blocks bid across all Active Bidders in the round minus the number of Auction Blocks offered for sale in the round.

The price increment guidelines limit the price increments to be between one (1) percent and twenty (20) percent of the Announced Prices for the most recently completed round.

In consultation with SELLER, the Auction Manager has discretion to override the price increment guidelines. The exercise of that discretion is expected to occur only rarely if at all, and only if doing so is believed to benefit the bidding process.

There is a Reserve Level for the MegaVoltCorp Auction. Auction Blocks will not be sold unless the Reserve Level is met in the auction. The Reserve Level will not be announced. There are no product-specific reserve prices in the MegaVoltCorp Auction.

In this example, the Starting Prices for the MegaVoltCorp Auction are the product-specific Announced Prices that are in effect for round 1. The Starting Prices for the MegaVoltCorp Auction will be at or below the level needed to satisfy the Reserve Level given the number of Auction Blocks offered for sale in the first round.

Because an Active Bidder may decide to change a bid it submitted previously within the current open round, it is allowed to make multiple bid submissions in a round as long as the round remains open for bidding, with each new bid fully replacing any prior bid it submitted in the round. If an Active Bidder submits multiple bids in a round, the only bid accepted in the round for that Active Bidder is the last bid that was submitted by and confirmed for the Active Bidder in the round.

After the end of a round, a default bid of zero Auction Blocks is submitted automatically on behalf of an Active Bidder that satisfies the following conditions:
Entered the round with positive Eligibility.
Did not submit a confirmed bid in the round.

As with any Active Bidder that bids zero Auction Blocks in a round, an Active Bidder having a default bid of zero Auction Blocks submitted on its behalf in a round will not be allowed to bid in any more rounds of the ascending clock phase.

The early rounds of bidding generally will be longer in duration than later rounds. The duration of a bidding round will be at least five minutes.

The time between early rounds of bidding generally will be longer in duration than for later rounds. The time between bidding rounds will be at least ten minutes.

The schedule of rounds and any changes to the schedule will be made available to Active Bidders through the Auction Software.

If there is insufficient demand for the Auction Blocks to ensure a successful auction, SELLER in consultation with the Auction Manager may reduce the number of Auction Blocks offered for sale.

If there is a reduction in the number of Auction Blocks offered for sale in the ascending clock phase, it mostly likely will occur only once during the ascending clock phase and it most likely will occur at the end of the first round. Although SELLER and the Auction Manager have the discretion to reduce the number of blocks offered for sale more than once during the ascending clock phase and to make such a reduction after any round in the ascending clock phase, it is unlikely that discretion will be exercised.

If the number of Auction Blocks offered for sale is reduced during the ascending clock phase, it will not be reduced below any one Active Bidder's Eligibility and the Auction Software will be used to inform Active Bidders of the revised number of Auction Blocks offered for sale.

As described in the section below on the sealed-bid round, the number of Auction Blocks selected as winning Auction Blocks in the sealed-bid round may be less than the number of Auction Blocks offered for sale in the ascending clock phase.

As discussed above, the Auction Manager establishes the “Transition Rule.” The Transition Rule is verified at stage 22. In this example, the Transition Rule is based on a relationship between Excess Demand and a predetermined value. That is, the Transition Rule indicates that the last round of bidding in the ascending clock phase is the first round of bidding in the ascending clock phase in which Excess Demand falls below a threshold number of Auction Blocks of Excess Demand. This threshold number of Auction Blocks of Excess Demand either will be zero or will have a positive value and will be determined prior to the MegaVoltCorp Auction. The threshold parameter value will not be announced.

In this example, the sealed-bid round phase will occur in stages 28 through 34, The sealed-bid round is the next round of bidding after the final round of bidding in the ascending clock phase. There is only one sealed-bid round and it is the final round in the MegaVoltCorp Auction. For ease of description, the last round of the ascending clock phase will be referred to as “round N” and the next-to-last round of the ascending clock phase will be referred to as “round N−1.”

Active Bidders for the sealed-bid round are those Qualified Bidders that submitted confirmed bids for at least one Auction Block in round N−1, and therefore had positive Eligibility as of the end of round N−1 and the beginning of round N. Any such Active Bidder must submit a bid in the sealed-bid round (even if it bid no Auction Blocks in round N and therefore had zero Eligibility as of the end of round N). If it fails to submit a bid in the sealed-bid round, a default bid will be submitted on its behalf as explained below.

Only Qualified Bidders that had positive Eligibility as of the end of round N−1 can submit a bid in the sealed-bid round.

While each round in the ascending clock phase has product-specific Announced Prices, there are no Announced Prices for the sealed-bid round. In the sealed-bid round, an Active Bidder submits a bid by specifying, for each Auction Block it bids, the highest product-specific price that the Active Bidder is committing to pay for the Auction Block.

When the Active Bidder enters its bid price for an Auction Block, the Active Bidder must specify which product the Active Bidder is associating with that price. This is required so the Price Indifference Formula can be applied. The Active Bidder actually is not committing itself to that particular product for that Auction Block: should that Auction Block be selected as a winning Auction Block, after the auction closes the Active Bidder will choose which product it will buy for that Auction Block. This is explained in more detail in the section below, “After the Close of the Auction”.

In the sealed-bid round, when the Active Bidder enters its bid price for an Auction Block and specifies which product is associated with that bid price, the Auction Software will display for that Auction Block all three product-specific prices—including the price entered by the Active Bidder—in accordance with the Price Indifference Formula.

Although in its sealed-bid round bid, the Active Bidder is not committing to a particular product for each Auction Block it bids, for each Auction Block included in the bid, the Active Bidder commits to buying either an Auction Block of the specified product at a price no higher than the Active Bidder's own bid price on that Auction Block, or an Auction Block of one of the other two products at prices that are no higher than the equivalent bid prices calculated by applying the Price Indifference Formula to the Active Bidder's own bid.

Should an Auction Block bid by the Active Bidder be selected as a winning Auction Block, the Auction Closing Price for the product that the Active Bidder associated with its bid price for that Auction Block will be no higher than the bid price submitted by the Active Bidder for that Auction Block.

The Auction Blocks in the Active Bidder's bid will be treated as a demand schedule by the Auction Software. That is, the Auction Blocks will be sorted in descending order by price corresponding to one of the products, and the price it bid for the first Auction Block is the maximum price the Active Bidder is committing to pay for the first Auction Block, the price it bid for the second Auction Block is the maximum price it is committing to pay for the second Auction Block, and so on.

The bid that an Active Bidder submits in the sealed-bid round must satisfy minimum price requirements. In short, the Active Bidder submits a bid price for each Auction Block it bid in the next-to-last round of the ascending clock phase, and the bid price it submits for an Auction Block must be no lower than the highest Announced Price for that Auction Block in the ascending clock phase. In more detail:
The Active Bidder's bid must include each of the Auction Blocks it bid in round N−1 (even if it bid fewer Auction Blocks in round N).
The minimum price the Active Bidder can bid for each Auction Block differs for Auction Blocks that it bid in both round N−1 and round N, and Auction Blocks that it bid in round N−1 but not in round N:
Auction Blocks that were bid in both round N−1 and round N. For each of the Auction Blocks, if any, the Active Bidder bid in round N (and therefore also bid in round N−1) the Active Bidder's bid in the sealed-bid round must specify a product and must specify a price that is at least as high as the Announced Price for that product in effect for round N. The Active Bidder can specify different products for the Auction Blocks it is bidding. If the Active Bidder specifies the same product for two or more Auction Blocks, the Active Bidder can submit different bid prices for those Auction Blocks but each bid price submitted must be at least as high as the Announced Price for that product in effect for round N. Default bid: If the Active Bidder's bid fails to specify a price for any of the Auction Blocks it must bid, the product for each such Auction Block will be deemed to be the 3-year contract and the bid price for each such Auction Block will be deemed to be the Announced Price for the 3-year product in effect for round N.
Auction Blocks that were bid in round N−1 but not in round N. For each of the Auction Blocks, if any, the Active Bidder bid in round N−1 but did not bid in round N, the Active Bidder's bid in the sealed-bid round must specify a product and must specify a price that is at least as high as the Announced Price for that product in effect for round N−1. The Active Bidder can specify different products for the Auction Blocks it is bidding. If the Active Bidder specifies the same product for two or more Auction Blocks, the Active Bidder can submit different bid prices for those Auction Blocks but each bid price submitted must be at least as high as the Announced Price for that product in effect for round N−1. Default bid: If the Active Bidder's bid fails to specify a price for any of the Auction Blocks it must bid, the product for each such Auction Block will be deemed to be the 3-year contract and the bid price for each such Auction Block will be deemed to be the Announced Price for the 3-year product in effect for round N−1.
   The units for prices specified in the Active Bidder's bid are dollars per kW-month, or $/kW-month. The level of precision accepted is $0.01/kW-month—that is, one cent per kW-month.

### Examples of Allowed Bids in the Sealed-Bid Round

Two illustrative examples follow. Prices are in units of $/kW-month but the numbers used in the examples are illustration only. Also, the actual user interface of the Auction Software may differ from the presentation of the examples below; prior to the auction a manual will be provided to Qualified Bidders that will show examples of the actual Auction Software screens.

### Example #1 of Allowed Bid in the Sealed-bid Round

### Given Bidder A's Bids in the Ascending Clock Phase

| | | | | Number of |
|---|---|---|---|---|
| | Price Announced by Auction Manager | | | Auction Blocks |
| | ($/kW-month) | | | Specified in |
| | P3 | P5 | P7 | Bidder A's Bid |
| Round N − 1 | 12.95 | 11.12 | 10.51 | 5 |
| Round N | 13.10 | 11.35 | 10.82 | 5 |

Bidder A could Submit this Bid in the Sealed-Bid Round

| | Minimum Required Price | | | Product and Price ($/kW month) | | |
|---|---|---|---|---|---|---|
| Auction | ($/kW-month) | | | Specified in Bidder A's Bid * | | |
| Block | P3 | P5 | P7 | P3 | P5 | P7 |
| 1 | 13.10 | 11.35 | 10.82 | 13.50 | 11.75 | 11.21 |
| 2 | 13.10 | 11.35 | 10.82 | 13.42 | 11.68 | 11.11 |
| 3 | 13.10 | 11.35 | 10.82 | 13.33 | 11.57 | 10.99 |
| 4 | 13.10 | 11.35 | 10.82 | 13.28 | 11.49 | 10.91 |
| 5 | 13.10 | 11.35 | 10.82 | 13.10 | 11.35 | 10.82 |

• For each Auction Block, Bidder A must select one of the radio buttons for P3, P5, and P7. Bidder A enters its bid price next to that selected radio button. The other two prices for the Auction Block are filled in automatically in accordance with the Price Indifference Formula.

In the example #1 above, in round N−1, the Announced Prices P3, P5, and P7 for the three products are 12.95, 11.12, and 10.51, respectively. Bidder A bids 5 Auction Blocks in round N−1. In round N, the Announced Prices P3, P5, and P7 are 13.10, 11.35, and 10.82, respectively. Again, Bidder A bids five Auction Blocks in round N.

Thus, in the sealed-bid round, Bidder A must submit a bid that includes the five Auction Blocks and includes a price for each Auction Block that is at least as high as the Announced Prices in round N.

Example #1 above shows that the bid submitted by Bidder A in the sealed-bid round satisfies this requirement. For the first Auction Block, Bidder A chooses to enter its bid price as a price for P3 and it enters a P3 price of 13.50 which is at least as high as the required price of 13.10 for P3—which was the Announced Price in effect for P3 when Bidder A bid the Auction Block in round N. When Bidder A enters its P3 bid price of 13.50, the corresponding prices for P5 (11.75 in the example) and P7 (11.21 in the example) are determined in accordance with the Price Indifference Formula.

Similarly, Bidder A enters its bid prices for the other four Auction Blocks it must bid in the sealed-bid round, choosing to enter prices for P3, P5, P7, and P5, respectively, for those Auction Blocks. Bidder A is not committing to the product corresponding to the bid price it enters for each Auction Block. Should the Auction Block be selected as a winning Auction Block, Bidder A will choose which product it will purchase for that winning Auction Block.

In example #2 below, the Announced Prices in the ascending clock phase are the same as in example #1 above. In example #2, Bidder B bids five Auction Blocks in round N−1 and only three Auction Blocks in round N.

### Example #2 of Allowed Bid in the Sealed-Bid Round

### Given Bidder B's Bids in the Ascending Clock Phase

| | | | | Number of |
|---|---|---|---|---|
| | Price Announced by Auction Manager | | | Auction Blocks |
| | ($/kW-month) | | | Specified in |
| | P3 | P5 | P7 | Bidder B's Bid |
| Round N − 1 | 12.95 | 11.12 | 10.51 | 5 |
| Round N | 13.10 | 11.35 | 10.82 | 3 |

Bidder B Could Submit this Bid in the Sealed-Bid Round

| | Minimum Required Price | | | Product and Price ($/kW month) | | |
|---|---|---|---|---|---|---|
| Auction | ($/kW-month) | | | Specified in Bidder B's Bid * | | |
| Block | P3 | P5 | P7 | P3 | P5 | P7 |
| 1 | 13.10 | 11.35 | 10.82 | 14.89 | 13.14 | 12.26 |
| 2 | 13.10 | 11.35 | 10.82 | 13.98 | 12.20 | 11.44 |
| 3 | 13.10 | 11.35 | 10.82 | 13.11 | 11.36 | 10.84 |
| 4 | 12.95 | 11.12 | 10.51 | 13.05 | 11.24 | 10.65 |
| 5 | 12.95 | 11.12 | 10.51 | 12.95 | 11.12 | 10.51 |

* For each Auction Block, Bidder B must select one of the radio buttons for P3, P5, and P7. Bidder B enters its bid price next to that selected radio button. The other two prices for the Auction Block are filled in automatically in accordance with the Price Indifference Formula.

In the sealed-bid round, Bidder B must submit a bid that includes the five Auction Blocks. For three of those Auction Blocks, Bidder B's bid prices must be at least as high as the Announced Prices in round N. For two of those Auction Blocks, Bidder B's bid prices must be at least as high as the Announced Prices in round N−1.

Example #2 above shows that the bid submitted by Bidder B in the sealed-bid round satisfies this requirement. For the first Auction Block, Bidder B chooses to enter its bid price as a price for P5 and it enters a P5 price of 13.14 which is at least as high as the required price of 11.35 for P5—which was the Announced Price in effect for P5 when Bidder B bid the Auction Block in round N. When Bidder B enters its P5 bid price of 13.14, the corresponding prices for P3 (14.89 in the example) and P7 (12.26 in the example) are determined in accordance with the Price Indifference Formula. Similarly, Bidder B enters its bid prices for the other four Auction Blocks it must bid in the sealed-bid round, choosing to enter prices for P5, P3, P3, and P7, respectively, for those Auction Blocks. The first two of those Auction Blocks have minimum required prices determined by the Announced Prices in round N, and the last two of those Auction Blocks have minimum required prices determined by the Announced Prices in round N−1. Bidder B is not committing to the product corresponding to the bid price it enters for each Auction Block. Should the Auction Block be selected as a winning Auction Block, Bidder B will choose which product it will purchase for that winning Auction Block.

As in the ascending clock phase, an Active Bidder is allowed to make multiple bid submissions in the sealed-bid round as long as the round remains open for bidding, with each new bid fully replacing any prior bid it submitted in the round. If an Active Bidder submits multiple bids in the round, the only bid accepted in the round for that Active Bidder is its last submitted and confirmed bid in the round. The scheduled duration of the sealed-bid round likely will be longer than the last rounds of the ascending clock phase in order to provide Active Bidders sufficient time to submit their bids.

After the end of the sealed-bid round (i.e., stage 34), the MegaVoltCorp Auction will close. At the close of the MegaVoltCorp Auction, the Winning Bidders will be determined and the product-specific Auction Closing Prices will be determined as follows.

The Auction Blocks from the bids in the sealed-bid round will be sorted in descending order by their associated 3-year contract price in accordance with the Price Indifference Formula. To break any ties, random numbers assigned to the Auction Blocks will be used to sort two or more Auction Blocks that have the same price. Higher random numbers are favored over lower random numbers. The assignment of random numbers to Auction Blocks and the sorting of Auction Blocks by price and by random number are done Auction Block by Auction Block without regard to Active Bidder.

In this example, the set of winning Auction Blocks from the sorted list of Auction Blocks is determined as follows.
Let P(q) be the 3-year contract bid price for the Auction Block with rank “q” in the sorted list. Thus, P(1) is the highest bid price, and P(Q) is the lowest bid price where Q is the number of Auction Blocks bid in the sealed-bid round.
Let “Auction Revenue” associated with the first—i.e., highest priced—“q”-ranked Auction Blocks be q×P(q).
Then the set of potential winning Auction Blocks is the set of “q” Auction Blocks that maximizes Auction Revenue. Let “qwin” be the rank of the lowest-priced Auction Block in the set of potential winning Auction Blocks.
If the set of potential winning Auction Blocks satisfies the Reserve Level, then this is the set of winning Auction Blocks, and the Auction Closing Price for the 3-year contract is P(qwin). The Auction Closing Prices for the other products are determined in accordance with the Price Indifference Formula.
If the set of potential winning Auction Blocks does not satisfy the Reserve Level, then there are no winning Auction Blocks.

Winning Bidders are the Active Bidders who submitted the winning Auction Blocks as part of their bids in the sealed-bid round.

None, some, or all of the Auction Blocks in an Active Bidder's bid in the sealed-bid round may be winning Auction Blocks.

Note that the number of winning Auction Blocks may be fewer than the number of Auction Blocks offered for sale in the ascending clock phase.

The example below shows how the Auction Blocks bid in the sealed-bid round are sorted and assigned random numbers. The example indicates that 15 Auction Blocks were bid in round N−1, but assume in this example that the number of Auction Blocks offered for sale is 12. Each Auction Block bid in the sealed-bid round is assigned a random number and the Auction Blocks then are sorted in descending order by the price P3 and in descending order by the assigned random numbers.

Starting with the highest-priced Auction Block, the Auction Revenue associated with the selection of each Auction Block as the lowest-priced winning Auction Block is computed. This Auction Revenue is shown in the last column, labeled q×P(q), of the table.

In the example, the Auction Revenue is maximized by selecting the highest-priced bids for all 12 Auction Blocks offered for sale. The maximized Auction Revenue shown below is 155.40 (using P3 as the price). The product-specific Auction Closing Prices P3, P5, and P7—to be paid for all winning Auction Blocks—are 12.95, 11.12, and 10.51, respectively. Bidder A has won five Auction Blocks, Bidder B has won five Auction Blocks, Bidder C has won one Auction Block, and Bidder E has won one Auction Block. Note that the Auction Blocks ranked 10 through 15 all had the same bid prices so the assigned random numbers were used to break the tie.

### Example of Selection of Winning Auction Blocks

| Block | Random # | Bid Price ($/kW-month) | | | | |
|---|---|---|---|---|---|---|
| Rank | Assigned | P3 | P5 | P7 | Bidder Name | q × P(q)* |
| 1 | 0.71516 | 14.89 | 13.14 | 12.26 | Bidder B | 14.89 |
| 2 | 0.07873 | 13.98 | 12.20 | 11.44 | Bidder B | 27.96 |
| 3 | 0.96295 | 13.50 | 11.75 | 11.21 | Bidder A | 40.50 |
| 4 | 0.96015 | 13.42 | 11.68 | 11.11 | Bidder A | 53.68 |
| 5 | 0.36376 | 13.33 | 11.57 | 10.99 | Bidder A | 66.65 |
| 6 | 0.06432 | 13.28 | 11.49 | 10.91 | Bidder A | 79.68 |
| 7 | 0.83464 | 13.11 | 11.36 | 10.84 | Bidder B | 91.77 |
| 8 | 0.37991 | 13.10 | 11.35 | 10.82 | Bidder A | 104.80 |
| 9 | 0.98870 | 13.05 | 11.24 | 10.65 | Bidder B | 117.45 |
| 10 | 0.74193 | 12.95 | 11.12 | 10.51 | Bidder C | 129.50 |
| 11 | 0.40761 | 12.95 | 11.12 | 10.51 | Bidder E | 142.45 |
| 12 | 0.34861 | 12.95 | 11.12 | 10.51 | Bidder B | 155.40 |
| 13 | 0.11654 | 12.95 | 11.12 | 10.51 | Bidder E | 168.35 |
| 14 | 0.09464 | 12.95 | 11.12 | 10.51 | Bidder C | 181.30 |
| 15 | 0.06641 | 12.95 | 11.12 | 10.51 | Bidder C | 194.25 |

*For each Auction Block that was bid, “q” is the Block Rank and “P(q)” is the 3-year contract price (P3) bid for that Auction Block.

After the close of the MegaVoltCorp Auction, each Winning Bidder will be informed of how many Auction Blocks it has won and the Auction Closing Price for each of the products.

For each of the Auction Blocks it has won, a Winning Bidder must choose and specify the product it will buy within one hour (60 minutes) after being informed of how many Auction Blocks it has won and the Auction Closing Price for each of the products. The price the Winning Bidder will pay for that Auction Block is the Auction Closing Price corresponding to the product it has specified. If the Winning Bidder fails to specify within that one hour time limit the product it will buy for each of the Auction Blocks it has won, the product for each such Auction Block will be deemed the product it specified for the Auction Block in the sealed-bid round.

The Auction Participation Agreement describes the post-auction obligations of Winning Bidders.

After the close of the auction, certain results of the MegaVoltCorp Auction will be posted to the public section of the Auction Information Web Site in accordance with the Auction Participation Agreement.

In this example, and as depicted in FIG. 3, the bidding in the MegaVoltCorp Auction can be conducted by accessing a secure bidding Web site. Authorized Representatives of Active Bidders will access the bidding Web site using their own Web browsers. The URL address for the bidding Web site, as well as Access Codes (user names and passwords), can be provided to Qualified Bidders prior to the start of the MegaVoltCorp Auction.

The bidding Web site provides Web pages that allow an Active Bidder to submit bids, to verify its status, to view results from prior rounds, to view the schedule of rounds, and to view messages from the Auction Manager. In general access to the bidding Web site requires all of the following:
User name and password provided by the Auction Manager.
Access to the Internet.
Microsoft Internet Explorer (“IE”) Web browser for Windows operating systems, version 6.0 or higher.
Status as an Active Bidder.

Note that a bidder loses access to the bidding Web site at the time it no longer is an Active Bidder and will not be eligible to bid in the sealed-bid round.

During a round, an Active Bidder can see the current status of the MegaVoltCorp Auction and the status of the current round—including the number of Auction Blocks for sale and the Announced Prices for a round in the ascending clock phase—as well as its own bidding status. An Active Bidder generally will not see information about other Active Bidders including the names of other Active Bidders.

Between rounds the bidding Web site will report the results for all completed rounds. The round results for each completed round will show:
For the completed round, the Announced Prices and a range of total demand across all Active Bidders (that is, a range of total number of Auction Blocks bid). The range of total demand will be defined by two different integers. Actual total demand will not be reported but will be at least as high as the lower of the two integers and no higher than the higher of the two integers. There is an exception to reporting total demand as a range of two integers: if and when total demand has declined in the ascending clock phase below a value Z, total demand will be reported as being below Z Auction Blocks. The value for Z will not be announced.
For each Active Bidder, that Active Bidder's bid for the round and the Active Bidder's Eligibility for the next round. (Each Active Bidder does not see information about other Active Bidders.)
The number of Auction Blocks offered for sale and the Announced Prices for the next round if the ascending clock phase will continue with the next round.

In real time, the Auction Manager will be able to see the status of the MegaVoltCorp Auction as well as individual bids by Active Bidders.

In an embodiment, the bidding Web site can display messages from the Auction Manager. These messages from the Auction Manager are displayed for all Active Bidders.

Each Active Bidder will be able to send messages to the Auction Manager. Other Active Bidders do not see these messages.

The network 100 can include data backup capabilities. In this example, in case an Active Bidder has technical difficulties, and as a result is not able to submit a bid via the bidding Web site in a round, a backup bidding procedure is provided as follows. The Active Bidder uses the “Backup Bidding Fax Number” that will be provided to Qualified Bidders to submit its bid via facsimile.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A system for implementing and conducting a 2-phase clock and sealed-bid auction for a multi-part product, comprising:
a plurality of remote computer stations operably connected to a network and configured to receive bids from a plurality of bidders;
a web server component operative to receive and store the bid information from the plurality of remote computer stations, receive and store auction parameters from an auction manager, and including application software configured to initiate a clock phase and a sealed-bid phase, wherein clock phase includes:
presenting the bidders with an initial price structure for the multi-part product;
receiving at least one bid for the multi-part product from each of the bidders within a defined time window;
storing the at least one bid for each of the bidders;
comparing the auction parameters and bids to a transition rule;
performing an end-of-round calculation;
presenting the results of the end-of-round calculation to each of the bidders;
initiating the sealed-bid phase based on the comparison between auction parameters and bids to the transition rule;
wherein, the seal-bid phase includes;
providing sealed-bid parameters to at least a subset of the bidders;
receiving a sealed-bid from at least a subset of the bidders; and
determining auction results based on a selection rule;
wherein the stored auction parameters includes at least the initial price structure, the defined time window, the transition rule, and the selection rule.

2. The system of claim 1 wherein the price structure of the multi-part component and the bids includes a price component and a quantity component.

3. The system of claim 2 wherein the transition rule is calculated by comparing the quantity of each product being auctioned to the quantity of bids for each product.

4. The system of claim 1 wherein the end-of-round calculation includes incorporating a price adjustment for at least one of the parts in the multi-part product.

5. The system of claim 1 wherein the defined time window in the clock phase is approximately between 1 and 60 minutes.

6. The system of claim 1 wherein the selection rule includes at least one rule for each part in the multi-part product.

7. The system of claim 1 wherein the clock phase is an ascending-price clock phase.

8. The system of claim 1 wherein the clock phase is a descending-price clock phase.

9. A computer-readable medium having computer-executable instructions for performing a 2-phase clock and sealed-bid auction for a multi-part product, comprising:
maintaining an auction bidding web site;
storing a plurality of auction parameters from an auction manager including at least an initial price structure, a first and a second defined time windows, a transition rule, and a selection rule;
providing a plurality of bidders with access to the web site;
presenting the bidders with auction rules and the initial price structure;
initiating a clock-phase comprising:
receiving through the web site a first bid for the multi-part product from each of the bidders within the first defined time window;
storing the at least one bid for each of the bidders;
comparing auction parameters and bids to the transition rule to determine if the clock-phase should continue;
performing an end-of-round calculation;
presenting the results of the end-of-round calculation to each of the bidders via the web site;
if the clock-phase continues, then receiving through the web site a second bid for the multi-part product from each of the bidders within the second defined time window;
if the clock-phase will not continue, then initiating a sealed-bid phase wherein, the seal-bid phase includes:
providing sealed-bid parameters to at least a subset of the bidders;
receiving a sealed-bid from at least a subset of the bidders; and
determining the auction results based on the selection rule.

10. The computer-readable medium of claim 9 wherein the clock phase is an ascending-price clock phase.

11. The computer-readable medium of claim 9 wherein the clock phase is a descending-price clock phase.

12. The computer-readable medium of claim 9 wherein the first defined time window is longer in duration than the second defined time window.

13. A method for implementing a 2-phase clock and sealed-bid auction for a multi-part product, comprising:
maintaining a database of auction parameters including at least an initial price structure and a transition rule;
providing a plurality of bidders with access to the a web site, wherein the web site is operably connected to the database;
presenting the bidders with the initial price structure via the web site;
initiating a clock-phase comprising:
receiving through the web site a bid for associated with the multi-part product from each of the bidders;
storing the at least one bid for each of the bidders in the database;
performing an end-of-round calculation;
presenting the results of the end-of-round calculation to each of the bidders via the web site;
initiating a sealed-bid phase based on the auction parameters, the bids received in the clock phase, and the transition rule, wherein the seal-bid phase includes:
providing sealed-bid parameters to at least a subset of the bidders;
receiving a sealed-bid from at least a subset of the bidders; and
determining the auction results.

14. The method of claim 13 wherein the clock phase is an ascending-price clock phase.

15. The method of claim 13 wherein the clock phase is a descending-price clock phase.

16. The method of claim 13 wherein the sealed-bid round does not occur and the auction results are determined based on the auction parameters and the bids received in the clock phase.

17. The method of claim 13 wherein the clock-phase does not occur based on the auction parameters, and the auction results are determined based on the auction parameters and the bids received in the sealed-bid round.

18. The method of claim 13 wherein the price structure of the multi-part component and the bids includes a price component and a quantity component, and the transition rule is calculated by comparing the quantity of each product being auctioned to the quantity of bids for each product.

19. The method of claim 13 wherein the bid information in the clock phase and the sealed-bid phase are received via email.

20. The method of claim 13 wherein the bid information in the clock phase and the sealed-bid phase are received via a facsimile system.
